(19) United States
(12) Patent Application Publication
(10) Pub. No.: US 2017/0298991 A1
(43) Pub. Date: Oct. 19, 2017

(54) BEARING HOUSING INCORPORATING COOLING PASSAGES

(71) Applicant: Poly-Tech Industrial Inc., Huntersville, NC (US)

(72) Inventor: Daniel Pompei Cedrone, Huntersville, NC (US)

(21) Appl. No.: 15/466,233

(22) Filed: Mar. 22, 2017

Related U.S. Application Data
(60) Provisional application No. 62/324,045, filed on Apr. 18, 2016.

(51) Int. Cl. F16C 37/00; F16C 17/02; F16C 35/02

(52) U.S. Cl. CPC F16C 37/00; F16C 35/02; F16C 17/02; F16C 2204/20; F16C 2204/26; F16C 2204/10

(57) ABSTRACT

A bearing apparatus includes a housing including a body with a first end face spaced apart from a second end face, and a housing bore extending through the body from the first end face to the second end face along a main axis, the body further including a plurality of cooling passages.

### BACKGROUND OF THE INVENTION

This invention relates generally to bearings and more particularly to bearing housings for use with plain bearings.

Various types of bearings are known and used for mounting shafts and other cylindrical structures for rotation with low friction. One particular type of bearing is a so-called “plain” bearing (or bushing) which comprises a cylindrical sleeve made of a material which provides a low coefficient of friction with the intended shaft material.

Plain bearings are typically carried or mounted in a housing which serves to support the bearing and provide a means for mounting the bearing to a static structure.

One problem with plain bearings is mounted in this manner is that they are subject to overheating because of an inability to transfer heat away from the bearing.

### BRIEF SUMMARY OF THE INVENTION

This problem is addressed by a bearing housing incorporating a plurality of cooling passages.

According to one aspect of the technology described herein, a bearing apparatus includes a housing including a body with a first end face spaced apart from a second end face, and a housing bore extending through the body from the first end face to the second end face along a main axis, the body further including a plurality of cooling passages.

According to another aspect of the technology described herein, a bearing apparatus includes: a housing including a body with a first end face spaced apart from a second end face, and a housing bore extending through the body from the first end face to second end face along a main axis, the body further including a plurality of cooling passages; a bearing received in the housing bore, the bearing defining a bearing bore; and a shaft mounted for rotation in the bearing bore.

### BRIEF DESCRIPTION OF THE DRAWINGS

The invention may be best understood by reference to the following description taken in conjunction with the accompanying drawing figures, in which:

FIG. 1 is a top plan view showing an exemplary bearing housing;

FIG. 2 is a cross-sectional view of the bearing housing shown in FIG. 1;

FIG. 3 is a top plan view showing a modification of the bearing housing of FIG. 1;

FIG. 4 is a cross-sectional view of the bearing housing shown in FIG. 3;

FIG. 5 is a top plan view showing another exemplary bearing housing; and

FIG. 6 is a cross-sectional view of the bearing housing shown in FIG. 5.

### DETAILED DESCRIPTION OF THE INVENTION

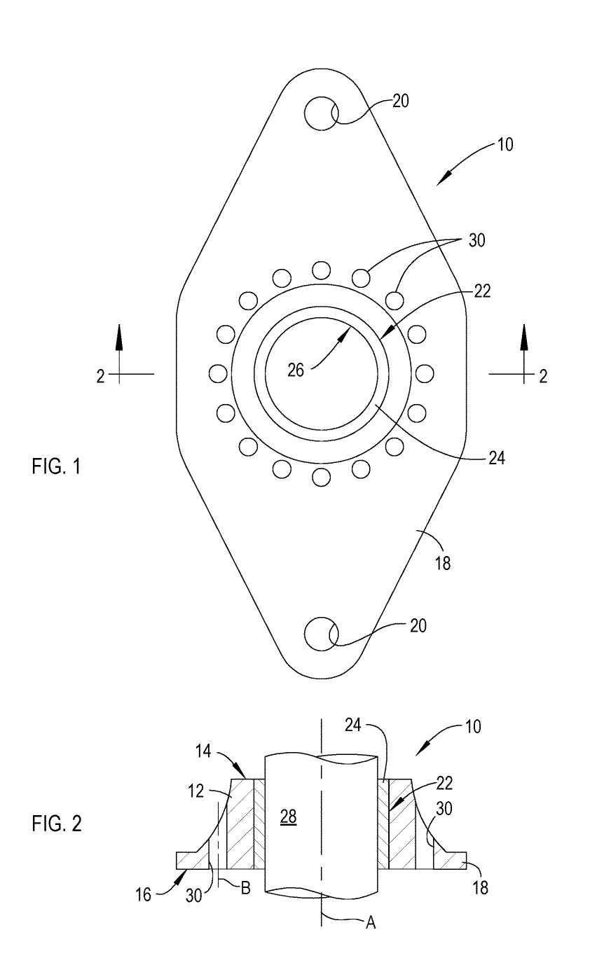

Referring to the drawings wherein identical reference numerals denote the same elements throughout the various views, FIGS. 1 and 2 illustrate an exemplary bearing housing 10. In general the bearing housing 10 has a body 12 with upper and lower surfaces 14 and 16 respectively (also referred to herein as end faces), and a peripheral flange 18 which may incorporate mounting holes 20.

The bearing housing 10 has a housing bore 22 formed therethrough parallel to a main axis “A”, and a bearing 24 is received in the housing bore 22. The bearing 24 is generally cylindrical and includes a bearing bore 26 sized to receive a shaft 28 (the shaft 28 is removed for clarity in FIG. 1 and is shown in FIG. 2). Nonlimiting examples of alloys suitable for the shaft 28 include iron, steel, and aluminum. The bearing 24 is a “plain bearing”, also referred to as a bushing, which achieves a friction reducing effect through choice of materials. In general the bearing 24 may be made from a material which is softer (e.g. has a lower hardness) than the shaft 28 and/or has self-lubricating properties. Nonlimiting examples of materials known for use as bearings include brass, bronze, lead, the tin- or lead-based alloys which are commonly referred to as Babbitt metal, graphite, and plastics, and various combinations and alloys thereof. The bearing 24 may be provided with one or more coatings or treatments to improve its wear resistance and/or reduce friction. It will be understood that the housing described herein could be used with other types of bearings such as rolling element bearings or hydrodynamic bearings.

The bearing 24 is stationary within the housing 10. The housing bore 22 and the outer diameter of the bearing 24 may be sized to provide an appropriate class of fit, for example a press-fit. Alternatively or in addition to the press-fit, the bearing 24 may be retained in the bearing housing 10 using means such as a mechanical joint, or one or more mechanical fasteners (not shown).

The bearing housing 10 may be constructed of a material having adequate strength to support and mount the bearing 24, for example a metal alloy. Preferably, the bearing housing 10 is made from a material having a high thermal conductivity. Nonlimiting examples of materials having high thermal conductivity include metals such as aluminum, magnesium, and copper, and their alloys.

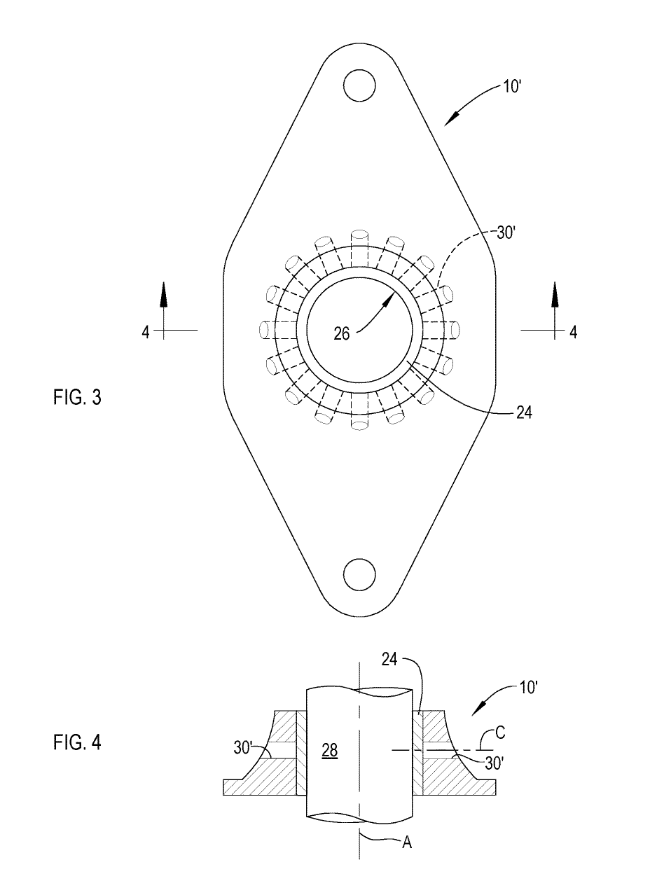

The bearing housing 10 has a plurality of cooling passages 30 formed therein. More specifically, an array of cooling passages 30 pass through the bulk of the bearing housing 10 in a location in relatively close proximity to the housing bore 22. In the illustrated example, a plurality of circular cross-section cooling passages 30 are disposed in a ring about the housing bore 22. In the example shown in FIGS. 1 and 2, the long axes “B” of the cooling passages 30 extend parallel to the main axis A. It will be understood the cooling passages 30 may be placed in any orientation. For example, FIGS. 3 and 4 show a variation of the bearing housing (labeled 10′) which includes cooling passages 30′ whose long axes “C” extend perpendicular to the main axis A.

In operation, the combination of mechanical load and rotation of the shaft 28 within the bearing 24 results in frictional heat generation. This heat energy is transferred to the bearing 24 and subsequently into the bearing housing 10 through conductive heat transfer. Many different designs of plain bearings are commercially available. Each specific bearing design can handle a certain speed-load combination characterized by a factor “PV”, where P represents the pressure or load, and V is velocity or speed. Generally, the higher the PV factor, the more expensive the bearing. The presence of the cooling passages 30 permits a flow of air or other fluid to transfer the heat away from the bearing housing 10. The presence of the cooling passages 30 increases the surface area available for convection heat transfer, and also reduces the distance that heat energy must travel through conduction through the wall thickness of the bearing housing 10, before reaching a lower temperature environment. The presence of the cooling passages 30 in conjunction with the use of a material with a high thermal conductivity will provide improved heat transfer and in many cases permit the use of a less capable bearing than would otherwise be required. For example it may permit the use of a less expensive plain bearing in place of a more expensive plain bearing, or it may permit the use of a plain bearing instead of a more expensive rolling element bearing or hydrodynamic bearing.

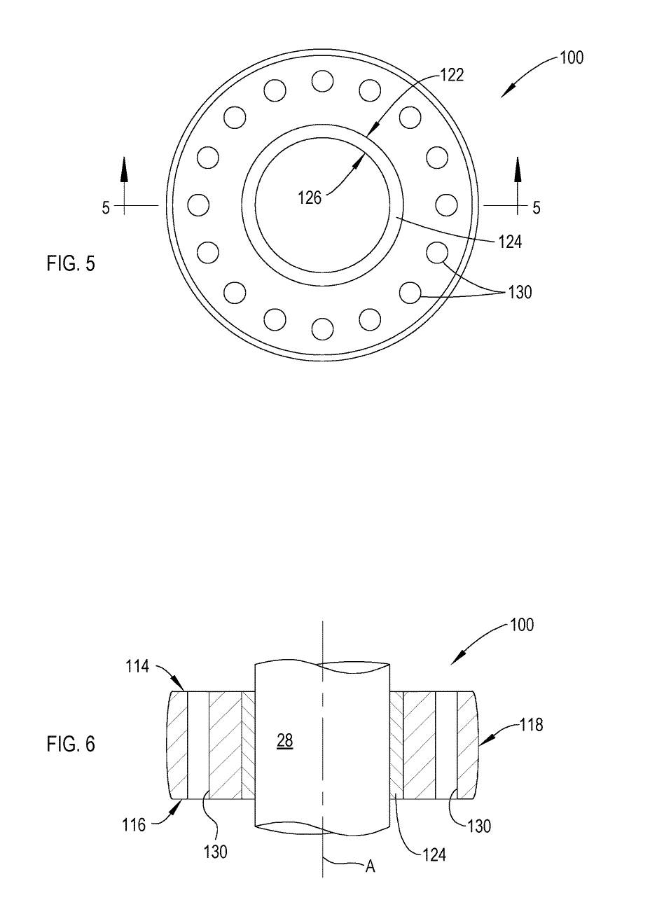

The concept of employing cooling passages may be extended to other types of bearing housings and/or support structures. For example FIGS. 5 and 6 illustrate an alternative bearing housing 100 having upper and lower surfaces 114 and 116 respectively (also referred to herein as end faces). The bearing housing 100 is generally similar in construction to the bearing housing 10 described above. Elements of the bearing housing 100 not specifically described may be considered to be identical to the bearing housing 10. A peripheral surface 118 of the bearing housing 100 has an arcuate shape (e.g. convex) so that the bearing housing 100 can be placed in a mount (not shown) which permits the bearing housing 100 to pivot in operation.

The bearing housing 100 has an outer bore 122 formed therethrough. A bearing 124 is received in the outer bore 122 and includes an inner bore 126 sized to receive a shaft 28 (the shaft 28 is removed for clarity in FIG. 5 and is shown in FIG. 6). The bearing 124 is a “plain bearing” as described above.

The bearing housing 100 has a plurality of cooling passages 130 formed therein. More specifically, an array of cooling passages 130 pass through the bulk of the bearing housing 100 in a location in relatively close proximity to the outer bore 122. In the illustrated example, a plurality of circular cross-section cooling passages 130 are disposed in a ring about the outer bore 122 and extend parallel to the main axis A. The cooling passages 130 function in the same manner as the cooling passages 30 described above.

The foregoing has described a bearing housing. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A bearing apparatus, comprising:
a housing including a body with a first end face spaced apart from a second end face, and a housing bore extending through the body from the first end face to the second end face along a main axis, the body further including a plurality of cooling passages.

2. The apparatus of claim 1 further comprising a bearing received in the housing bore, the bearing defining a bearing bore.

3. The apparatus of claim 2 wherein the bearing is a plain bearing.

4. The apparatus of claim 3 wherein the bearing comprises a material which has self-lubricating properties.

5. The apparatus of claim 1 wherein the cooling passages are arranged in a ring around the housing bore.

6. The apparatus of claim 5 wherein the cooling passages extend parallel to the main axis.

7. The apparatus of claim 5 wherein the cooling passages extend perpendicular to the main axis.

8. The apparatus of claim 1 wherein the body includes a peripheral flange extending beyond the cooling passages.

9. The apparatus of claim 1 wherein the body includes a peripheral surface which has an arcuate shape.

10. The apparatus of claim 1 wherein the housing is made from a metal with high thermal conductivity selected from the group consisting of: aluminum, magnesium, copper, and alloys thereof

11. A bearing apparatus, comprising:
a housing including a body with a first end face spaced apart from a second end face, and a housing bore extending through the body from the first end face to second end face along a main axis, the body further including a plurality of cooling passages;
a bearing received in the housing bore, the bearing defining a bearing bore; and
a shaft mounted for rotation in the bearing bore.

12. The apparatus of claim 11 wherein the bearing is a plain bearing.

13. The apparatus of claim 11 wherein the bearing comprises a material which is softer than the shaft.

14. The apparatus of claim 13 wherein the material softer than the shaft is selected from the group consisting of: brass, bronze, lead, Babbitt metal, graphite, and plastics, and combinations thereof

15. The apparatus of claim 11 wherein the cooling passages are arranged in a ring around the housing bore.

16. The apparatus of claim 15 wherein the cooling passages extend parallel to the main axis.

17. The apparatus of claim 15 wherein the cooling passages extend perpendicular to the main axis.

18. The apparatus of claim 12 wherein the body includes a peripheral flange extending beyond the cooling passages.

19. The apparatus of claim 12 wherein the body includes a peripheral surface which has an arcuate shape.

20. The apparatus of claim 12 wherein the housing is made from a metal with high thermal conductivity selected from the group consisting of: aluminum, magnesium, copper, and alloys thereof.
